(19) United States
(12) Patent Application Publication
(10) Pub. No.: US 2002/0169853 A1
(43) Pub. Date: Nov. 14, 2002

(54) Accessing and recording information via the internet for specific products, services and transactions

(76) Inventor: James Grossman, Westport, CT (US)

Correspondence Address: CANTOR COLBURN, LLP, 55 GRIFFIN ROAD SOUTH, BLOOMFIELD, CT, 06002

(21) Appl. No.: 10/138,016

(22) Filed: May 3, 2002

Related U.S. Application Data
(60) Provisional application No. 60/289,833, filed on May 9, 2001.

(51) Int. Cl. G06F 15/16

(52) U.S. Cl. 709/218

(57) ABSTRACT

An embodiment of the invention comprehends an improved method of identifying and retrieving information by providing or assigning a unique identifying indicia to goods and services, to entities such as government agencies and businesses, to places such as cities, states and national parks, which unique identifying indicia corresponds to an address or means for locating corresponding information stored in electronic form that is accessible via the worldwide web, or Internet.

### CROSS-REFERENCE TO RELATED APPLICATIONS

This application claims the benefit of U.S. provisional application serial No. 60/289,833 filed May 9, 2001, the entire contents of which are incorporated herein by reference.

### FIELD OF THE INVENTION

The invention relates to the identification of digitally recorded information about products and services that is stored in databases that can be accessed via the Internet or other computer network.

### BACKGROUND

Using the Internet or worldwide web of computers to obtain information about a specific product, service, company or organization can be time-consuming and often requires the information seeker to employ search techniques and apply logic that is neither straightforward nor intuitive. Although massive amounts of information are made available by product manufacturers and service providers at interactive websites that they have created and maintain for that purpose, direct, rapid access to this information by a first-time researcher is not the norm. To the contrary, surveys have shown that 80%, or even more, of Internet users are unable to locate the information sought during the course of a given search.

Uniform systems for identifying specific products manufactured by vast numbers of producers and sold throughout the world have already been adopted to facilitate and expand commerce in these products. For example, the Universal Product Code, or UPC, and associated bar code marking or labeling of products has been in common use on a world wide basis for many years. The use of bar codes based on an optical scanning system for entering information into a digital computer's database continues to expand into diverse service arenas and be used in various aspects of manufacturing operations.

It has also been known for various types of commercial industrial and governmental entities to apply bar codes for inventory control, identification and locator purposes.

There is currently no single, logically organized interactive website that a person can visit via the Internet to obtain information about a specific product, company, organization or service using a unique identifying indicia that is assigned only to the specific product, service, or entity.

### SUMMARY OF THE INVENTION

An embodiment of the invention comprehends an improved method of identifying and retrieving information by providing or assigning a unique identifying indicia to goods and services, to entities such as government agencies and businesses, to places such as cities, states and national parks, which unique identifying indicia corresponds to an address or means for locating corresponding information stored in electronic form that is accessible via the worldwide web, or Internet.

In one embodiment, the invention comprehends a method of applying or associating a unique identifying indicia to a specific product or service, which indicia can be entered by an interested party in a computer terminal linked to the Internet to access one, or more than one website that is maintained for the purpose of linking the party with a digital database containing information about the specific product or service, without additional identifying or search information or indicia.

In the practice of the invention, the product manufacturer or other source or sponsor applies a unique identifying indicia to the product in a position that is visible or readily accessible. The use of bar codes is already common and in widespread use on existing products. Such bar codes can be read by readily-available scanners that are available for use with personal computers by consumers. Each unique bar code corresponds to a multi-digit number that can be entered via the keyboard.

Information about each product or service is stored in a database maintained by the product's manufacturer, or other sponsor, at an address or location that corresponds to the unique identifying indicia, e.g., the UPC bar code number. In a further embodiment of the invention, the database also includes means for receiving and storing for retrieval and display comments transmitted by consumers and others that relate to the specific product or service. These incoming transmissions are also addressed using the unique identifying indicia.

The link between the researcher's computer terminal and the informational database can be established via one, or more than one website that is established for this purpose, or by the researcher's Internet service provider using existing search engines. In the embodiment where a special website is established, the website sponsor can provide hyperlinks to the manufacturer's website and database. Alternatively, the website sponsor can provide data storage means and servers for directly routing researchers' inquiries or transmitted comments.

The method and apparatus of the invention enables consumers and other interested parties a foolproof way to quickly and efficiently obtain information about specific products and services by use of a unique identifying indicia.

### BRIEF DESCRIPTION OF THE DRAWINGS

FIG. 1 is a block diagram of an exemplary system for recording and accessing information.

### DETAILED DESCRIPTION OF THE INVENTION

The following definitions apply to the terms used in the description of the invention:

“Unique identifying indicia” means a numeric, alphabetic, alpha-numeric or symbolic code, and codes formed from any of the above elements, that is assigned to, or associated with, a single product or product line. Examples of existing or prior art usages of such indicia include UPC for a wide variety of products and Vehicle Identification Numbers (VIN) affixed to motor vehicles.

“Indexing database” means a digital memory or data storage device in which are entered listings of unique identifying indicia, and optionally, a brief textual description, a machine searchable listing of the unique identifying indicia for each of the plurality of products/services for which information is available for retrieval and transmission to an interested party.

“Informational database” means a machine searchable listing of descriptive product/service information provided by the source of the product/service, e.g., specifications, assembly, operating and repair instructions, warranty, and the like, as well as comments entered by interested third-parties, e.g., user observations, government warnings and recalls, and the like.

The unique identifying indicia can be applied or affixed to the product by any currently known means, or means developed in the future, including printed labels, embossing, 3-dimensional casting, holography, smart chips producing visual or audible messages and direct electronic signals; by watermarks or machine readable indicia, such as magnetic ink characters. Other communications media, i.e., newspapers, magazines, radio, television and videotapes, can also be used to convey the indicia along with other advertising for a product or service.

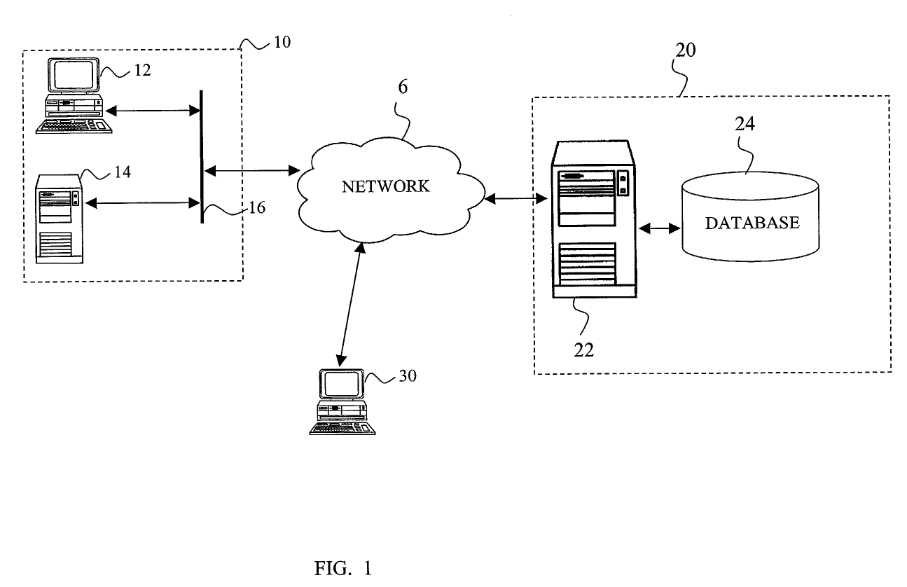

FIG. 1 is a block diagram of an exemplary system for recording information. An information system 20 is coupled to a provider system 10 and a terminal 30 by a network 6. The network 6 may be any type of known network including a wide area network (WAN), secure network (e.g., extranet, virtual private network), global network (e.g., Internet), etc. One or both of the provider system 10 and the information system 20 may be connected to the network 6 in a wireless fashion. In a preferred embodiment, the network 6 is the Internet.

The system of FIG. 1 also includes one or more remote terminals 30. The remote terminal 30 may be used to access product/service information through information system 20 and optionally submit user information to information system 20. The remote terminal 30 may be implemented using a general-purpose computer executing a computer program for carrying out the processes described herein. Remote terminal 30 may include a scanner for reading the unique identifying indicia from a product or service-related material (e.g., advertisement). In a preferred embodiment, the remote terminal 30 executes a user interface application (e.g., web browser) to access information system 20 over network 6. The remote terminal 30 may be connected to network 6 in a wireless fashion and may be a any type of web-enabled device such as a laptop, PDA, cell phone, etc.

The provider system 10 may correspond to a system maintained by a provider of a product or service. The provider system includes a provider terminal 12 which may be implemented using a general-purpose computer. A provider server 14 is coupled to the provider terminal by a network 16 (e.g., LAN). The provider server 14 stores product information and/or service information in a manner accessible (e.g., HTML, pdf) over network 6.

The information system 20 includes a server 22 and a database 24. Server 22 contains content (e.g., HTML files) defining a website, referred to herein as InfoDemo.com. The database 24 may include indexing database and a informational database, as described in further detail herein. The database 24 may be part of server 22 or a separate physical device accessible by server 22. The server 22 may be implemented using commercially available servers executing a computer program to implement the processes described herein. The server 22 acts as a database server to store and retrieve product/service information in database 24. The server 22 also acts as a network server to interact with provider 10 and remote terminal 30.

Database 24 may be a relational database containing digital data stored for retrieval (e.g., read only memory). The database includes a first data field containing unique identifying indicia each of which is associated with one of a plurality of product/services from a plurality of unrelated product/service sources. A second data field is linked to the first data field. The second data field contains descriptive product/service information that is specific to each of the plurality of product/services, whereby an inquiry directed to the first data field in terms of the unique identifying indicia results in the display of the corresponding descriptive product/service information from the second data field. In operation, a user at terminal 30 can access a unique identifying indicia in the first field, when then provides the user with product/service information via second data field. The second data field may include links to a plurality of product/service source databases electronically linkable to the first data field over network 6. Referring to FIG. 1, the second data field may include a hyperlink to provider server 14 where product information and/or service information is contained.

In another embodiment, server 22 receives information from terminal 30. The database 24 retrievably stores digital data received via network 6 from remote terminal 30 in association with a unique identifying indicia corresponding to that contained in the first data field. Such information from a terminal may include user comments about a product or service. Server 22 and/or database 24 may use security encoding to limit access to the data received in association with a particular unique identifying indicia to the source of the corresponding product/service. In other words, a provider of a product/service may review user comments. Database 24 may also contain the return address of an interested party in association with a unique identifying indicia entered by the interested party.

In operation, server 22 receives an inquiry from a remote terminal 30 including a unique identifying indicia. Through the first data field, server 22 locates the product/service information related to the unique identifying indicia. The second data field provides a link to product/service information. The product/service information may be stored directly at database 24 and provided to terminal 30. Alternatively, the second data field may define a link to a provider website enabled, for example, by server 14 through which additional product/service information is retrievably stored for display. The product/service information from the provider's website is transmitted for display at the remote terminal 30.

The remote terminal may be used to provide third party information to database 24. A user at terminal 30 may submit third party information and a unique identifying indicia to server 22. This third party information is then added to database 24 associated with the first data field corresponding to the unique identifying indicia. As noted above, the third party information may be encoded so that only the provider associated with the unique identifying indicia can access the third party information. In addition, the third party information may also include the user's address, e-mail address, telephone number etc. so the provider may contact the user for additional information. The third party information may be stored according to at least one category identifier associated with the third party information and is retrieved for display in response to a request accompanied by a category identifier. Exemplary categories include problems, suggested improvements, advantages and questions.

In one embodiment, all stored product and service information that has been assigned a unique identifying indicia can be accessed by visiting a single website on the Internet. For the purposes of describing this preferred embodiment, the hypothetical website is assigned the domain name, or address, InfoDemo.com and the unique identifying indicia are denominated “InfoDemo Numbers” (“IDN”). Thus, in this context, the InfoDemoNumber (IDN) is the unique number that associates a product, service or entity with a single website for accessing the desired information, e.g., specific product information, demonstrations and feedback. The method of the invention eliminates the need for an endless variety of cumbersome, scattered, varied, and untimely search methods. Products are assigned an easy-to use identifier that takes an interested party to a single, centralized website. The consumer is provided with means for commenting on every product and does not have to go to a different source's location every time. Using unique identifying indicia the customer or researcher can obtain a variety of product/service information and provide all types of comments and feedback. This embodiment of the invention provides one website that is meaningful, rewarding, in real time, that is cost effective and universally recognized. It provides a streamlined feedback method by replacing numerous alternative methods and simplifying them for easy use and accessibility by all that are interested.

A manufacturer can offer enhanced online informational services to purchasers as a way of improving its competitive position, or it can charge the purchaser for demonstrations and how-to information that is downloaded at the time of the Internet access.

The method of the invention can also be applied to facilitate and expedite the purchase of accessories, service contracts, supplies and related products from the manufacturer or other sources. For example, the purchaser of a relatively expensive shop tool, such as a table saw or lathe can use the unique identifying indicia to subsequently access the manufacturer's interactive website and obtain information about accessories, replacement parts and related equipment. Other suppliers of supplies, e.g., saw blades or cuffing tools, can also be accessed using the unique identifying indicia. Advanced how-to information and demonstrations can be sold in electronic format as the purchaser expands his knowledge and use of the machine. Safety warnings, recalls and service reminders can be transmitted via e-mail to purchasers that have electronically registered using the unique identifying indicia.

Operators of Internet auction sites can use the unique identifying indicia with appropriate meta tags or hyperlinks to direct potential purchasers to detailed information about product/services maintained at other websites to reduce the amount of memory or data/storage means required to operate their own auction commerce.

The following examples are intended to be illustrative of the method and apparatus of the invention and representative of the manner in which it can be practiced for the benefit of product manufactures, service providers and consumers of such products and services.

The purchaser of a new stereo system locates the IDN on the product and addresses the InfoDemo.com website. The customer then types in, scans, or otherwise enters the IDN and immediately has options for demonstrations of the product, information on assembly, related products, registration information, warranty information, and customer service. In the case where the products manufacturer or other sponsor has provided access to a database storage means corresponding to the product, the consumer, optionally, has an opportunity to provide the consumer's own comments or feedback. The customer has the ability in real time to tell how she liked a product without having to send back a reply card, call an 800 number, or write a letter. Each customer has an immediate and equal opportunity to critically comment.

If desired, the IDN can be expanded to include a specific product's serial number, e.g., the VIN for automobiles. If the company chooses, it can assign further or supplemental IDNs to identify where and when the product was purchased. Each product model or line bears its own unique identifying indicia or IDN number, and all that is required is to access the one specialized website for any product that carries an IDN.

In accordance with the invention, any organization and all forms of media can utilize the same effective way for any and all of the people who are involved with it and use it to respond. This was not possible before the invention. In the past, the customer's thoughts and opinions reached only a few people, were soon forgotten, got lost in the shuffle, didn't matter to many, didn't change anything, weren't published. With the invention, these comments are recorded in a specific and organized fashion, are there for the specific purpose of being read by others, can have an impact, have more potential to change things and will be published. This embodiment of the invention provides a very affordable means to obtain consumers' comments for small businesses or individual marketers. Such comments can be solicited in a uniform format provided by the source of the products and services in order to form the basis of an opinion poll or survey than can be computer-tabulated.

Magazines and newspapers would no longer be to publishing a select few letters to the editor. An indexed newspaper website can record hundreds of letters of readers' commentary. Instant real time feedback for advertisers is also possible utilizing the invention. Every article in every newspaper or magazine can be assigned a unique identifying indicia for identification and receiving and recording associated commentary, and for the first time a reader can send a letter to the editor or comment on a magazine and instantaneously have it published. Writers have a new expanded vehicle for receiving literary comments. Publishers can publish more copy, there can be thousands of reviews. Want to know more about a movie before you go see it? Go to InfoDemo.com for comments. Want to comment afterwards? Go to the InfoDemo.com website. Comments about specific actors, music or other aspects of the entertainment can be recorded.

Websites can be designed to receive commentary and criticism in specified formats that facilitate and prompt the user, and also permit real time compilation of data. For example, theatrical performances, television shows, even restaurant meals can be rated by consumers using a standardized format for each, e.g., a questionnaire that prompts the consumer to enter that corresponds to the specific flight. A passenger that was pleased or dissatisfied with any aspect of the flight can log on to a website operated by the FAA, the airline and/or InfoDemo.com, enter the unique identifying indicia and register his comments: the first class flight attendant was very helpful; or the seat at location 24C was broken. Consumer rating information is obviously important in improving service and safety condition, but in most instances, business travelers and others do not wish to suffer the time and expense burden of trying to locate the proper agency or individual to report the problem and preparing the correspondence. The method of the invention provides the means for rapidly, efficiently and effectively reporting the problems to the organizational entity that can or should take appropriate action.

The method of the invention is particularly adapted for use by governmental agencies at all levels that rely on consumers to report problems with goods and service providers in order to take remedial action or impose penalties. Every automobile has a VIN and the DOT website can be formatted to provide the appropriate prompts to vehicle owners that with to report problems. The SEC can assign unique identifying indicia to securities dealers, and dealer representatives, such as salesmen, can be quickly and easily reported for improper activities. Such reports would be maintained confidential and appropriate measures to identify the source.

Airline reservation holders can also use the unique identifying indicia to quickly confirm their plans, determine reported departure delays and flight status, connecting flights, enter special meal orders and the like. Purchasers of services or products that register with the manufacturer can elect to receive future maintenance reminders, such as oil change or filter replacement schedules on automobiles, tools and major appliances. Change of postal or e-mail addresses can be entered quickly with numerous suppliers using the unique identifying indicia to access the desired database.

In addition to providing consumers with an easily accessible reference for seeking information, consumers and other interested parties can register their own postal or e-mail addresses in association with a particular, specific product or service unique identifying indicia, so that catalogs, updated instructions and the like would be released whenever available for transmittal by e-mail or postal direct mail service.

In other embodiments of the invention, individuals or other entities can establish their own listings of product and service unique identifying indicia to be made accessible to others, on a limited or an unlimited basis, for a variety of purposes. For example, a bridal registry can list the unique identifying indicia, and prospective gift-givers can quickly obtain as much information as they desire concerning the product or services listed, including cost. Individuals and business can use the unique identifying indicia as a product or service “wanted’ listing to facilitate Internet searching and contacts by third parties who wish to sell or provide the products or services.

The invention has the potential for changing the way companies interact with their customers because businesses can now know in real time what the customer wants or has to say about the products or services sold or offered. The invention provides a method of managed feedback. The president of a company can read what his customers have to say about his company's product or service that day and have the ability to respond to that customer in any manner he chooses and to share the information with whomever he wants. A company can now vary feedback by region to drive product offers with unique feedback numbers.

The invention provides the ability to outsource comments and suggestions in a uniform and visual way. For businesses, Standard Operating Procedures on invoices and bills can go to an IDN to record feedback. For electronic forms, a direct link can be established. A corporate feedback center address can be printed on every invoice. For the first time the average consumer has the ability to influence designing of product or service features. The invention can provide consumer/user feedback as soon as the product is in the customer's hands. Every company, no matter how big or small can benefit. The IDN can be a tool with an endless variety of applications, and can function to build consumer loyalty.

In the field of entertainment, professional and/or laymans' reviews of plays, music, books, even ballgames are organized by category. Each individual performance of a play on Broadway can be the subject of a nightly review. The individual's opinion can be shared with the world via the access afforded by the Internet. This review section can be extended to an unlimited range of products, operas, books, clothes, fashion, restaurants, airline flights, hotel rooms, rental cars, machines, canned goods, restaurant meals, i.e., to include all types of services and transactions. In the case of transitory services such as airline flights, the unique identify indicia can be entered on the ticket stub. In the case of restaurant services, the customer's receipt can be marked with indicia that include the date, place and even the server, if desired.

Consumer feedback can be recorded without charge, if sponsored by the company. A company can pay for feedback or submitters can be rewarded in kind. For example, a magazine publisher can provide incentive offers with subscriptions, such as ten pages of feedback for a two-year subscription, or can provide a specific page for its subscribers only.

Rewards can be offered for the most useful and helpful feedback. Rewards can come in the form of member points: e.g., a hotel patron can receive points for feedback such as an upgrade or reduced rate on a more expensive room the next visit. Points for feedback or filling out a special questionnaire via the Internet. TV shows can sponsor contests for the next season. All information can be compiled and edited to be distributed in a variety of ways, e.g., the best, the greatest, etc.

Another information feedback category is for new products or services that consumers have identified as being particularly well-designed, useful or responsive to a long-felt need. Comments can be specifically solicited as to how the customer would improve the product, with awards being given to the submitter of the best product improvement suggestions. Product manufacturers can solicit interested consumers to participate in focus groups or provide chatrooms that can be monitored by management or market researchers for an analysis of consumers' likes about the product or product category. Alternatively, the independently website operator can collect, analyze and sell such market research information to others.

The invention provides the customer with a new and more effective means for exercising the consumer's freedom of speech, and an equal opportunity to be heard. A single website permits the consumers of the world to give feedback on listed products and services. The unique identifying indicia permits the consumer to quickly “go on record” as to a specific product or service. The invention also provides the ability for others, including management, to learn what consumers and other reviewers have said about a specific product or service.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. A method of providing access to product information for a plurality of products from a plurality of product providers and service information for a plurality of services from a plurality of service providers in response to inquiries via the Internet, the method comprising:
providing a primary interactive Internet website responsive to inquiries from remote terminals;
providing a memory storage device containing product and service information in digital form for each of the plurality of products and services;
providing each of the plurality of products and services for which product information and service information is to be made accessible via the website with a unique identifying indicia;
publishing the unique product identifiers and the service identifiers; providing data storage means in association with the website;
retrievably storing each of the unique identifying indicia and associated product information and service information in the data storage means; and
retrieving product information and service information from the data storage means for display at a remote terminal in response to an inquiry from the remote terminal accompanied by the corresponding unique identifying indicia for the product or service.

2. The method of claim 1 which further comprises:
providing linking means between the primary website to a product provider's website through which additional product information is retrievably stored for display;
establishing a link between the primary website and the product provider's website in response to an inquiry from a remote terminal accompanied by the corresponding unique identifying indicia; and
transmitting the product information from the product provider's website via the linking means for display at the remote terminal.

3. The method of claim 1 where the unique identifying indicia comprises the universal product code assigned to that product.

4. The method of claim 1 where the unique identifying indicia is selected from the group consisting of numerals, alphabetic characters, bar codes, and combinations thereof.

5. The method of claim 1 where product information is selected from the group consisting of product images, operating and assembly instructions and demonstrations, repair procedures, performance specifications, purchase price, warranty provisions, term and registration procedures, related products and services, repair service, return and replacement policies, and combinations thereof.

6. The method of claim 5 where the product information is transmitted for display in a form selected from a group consisting of photographic images, virtual video images, text, audio, animations, and combinations thereof.

7. The method of claim 1 which further comprises:
retrievably storing input data received from the remote terminal in the data storage means in association with a unique identifying indicia; and
retrieving the input data for display at a remote terminal in response to a request for such input data display accompanied by the identifying indicia.

8. The method of claim 7 where the input data is stored according to at least one category identifier associated with the input data and is retrieved for display in response to a request accompanied by a category identifier.

9. The method of claim 8 where the category identifier is selected from the group consisting of problems, suggested improvements, advantages and questions.

10. The method of claim 1 where the unique identifying indicia are published by applying the indicia to the product that it identifies.

11. The method of claim 1 where the unique identifying indicia are published in the form of printed materials distributed in associated with the rendition of the services.

12. An improved apparatus for storing and making available for retrieval via the Internet information about a plurality of products from a plurality of unrelated product sources, each of said products having an associated unique identifying indicia, said apparatus comprising:
one or more indexing databases in which are stored the unique identifying indicia associated with each of said plurality of products;
one or more informational databases in which are stored descriptive product information that is specific to each of said plurality of products;
means for linking the one or more indexing databases with one or more informational databases;
access means for linking the one or more indexing databases to the Internet, and
means for retrieving and transmitting the stored descriptive product information in response to a request received via the Internet in association with the unique identifying indicia received via the Internet.

13. A relational database containing digital data stored for retrieval in the form of read only memory, the database comprising:
a first data field containing unique identifying indicia each of which is associated with one of a plurality of products from a plurality of unrelated product sources; and
a second data field linked to the first data field, the second data field containing descriptive product information that is specific to each of the plurality of products, whereby an inquiry directed to the first data field in terms of the unique identifying indicia results in the display of the corresponding descriptive product information from the second data field.

14. The relational database of claim 13 where the first data field is accessed via a website on the Internet.

15. The relational database of claim 13 where the second data field comprises a plurality of product source databases electronically likable to the first data field via the Internet, where each of the product source databases is maintained by the source of one or more of the plurality of products identified in the first data field.

16. The relational database of claim 13 that further comprises input data storage means for retrievably storing digital data received via the Internet from a remote terminal in association with a unique identifying indicia corresponding to that contained in the first data field.

17. The relational database of claim 16 that further comprises encoding means in association with the input data storage means, said encoding means limiting the access to the data received in association with a particular unique identifying indicia to the source of the corresponding product.

18. The relational database of claim 17 that further comprises data storage means for receiving and recording the return address of an interested party in association with a unique identifying indicia entered by the interested party.
